(19) United States
(12) Patent Application Publication
(10) Pub. No.: US 2015/0362413 A1
(43) Pub. Date: Dec. 17, 2015

(54) MICRODEVICES FOR SEPARATION OF NON-SPHERICAL PARTICLES AND APPLICATIONS THEREOF

(71) Applicant: NATIONAL UNIVERSITY OF SINGAPORE, Singapore (SG)

(72) Inventors: Yong Zhang, Singapore (SG); Shashi Ranjan, Singapore (SG); Zeming Kerwin Kwek, Singapore (SG)

(73) Assignee: National University of Singapore, Singapore (SG)

(21) Appl. No.: 14/761,790

(22) PCT Filed: Jan. 23, 2014
(86) PCT No.: PCT/SG2014/000028

§ 371 Date: Jul. 17, 2015

Related U.S. Application Data
(60) Provisional application No. 61/849,331, filed on Jan. 24, 2013.

(51) Int. Cl. G01N 1/40; B01D 21/00; B01L 3/00

(52) U.S. Cl. CPC G01N 1/4077; B01L 3/5027; B01L 3/502761; B01D 21/00; B01L 2200/10; G01N 2001/4083

(57) ABSTRACT

The invention concerns at least one pillar in, or for use in, a microfluidic device wherein said pillar comprises, in cross-section, at least one particle abutment surface and an adjacent space that indents said pillar, or an adjacent groove that indents said pillar, to accommodate said particle; a plurality of such pillars arranged in an array; a method for separating particles in a fluid using said pillar, array or said device; and a diagnostic method involving the separation of particles from a fluid using said pillar, array or said device.

The invention relates to at least one pillar in, or for use in, a microfluidic device said pillar comprising in cross-section at least one particle abutment surface and an adjacent space that indents said pillar, or an adjacent groove, to accommodate said particle; a plurality of such pillars arranged in an array; a method for separating non-spherical particles in a fluid using said pillar, array or said device; and a diagnostic method involving the separation of selected cells from a fluid using said pillar, array or said device.

### BACKGROUND OF INVENTION

The capacity to isolate various biological entities such as pathogens and blood components enables the diagnosis and detection of diseases, infections and biological threats. Traditional processes of separating these biological entities or bioparticles involve cumbersome bench-top equipment employing centrifugal techniques, filtering, culturing and isolating. Advances in micro-machining have resulted in the development of microfluidic devices where bioparticle separation can be integrated with other processes and performed at a micro level commonly known as “lab-on-a-chip”. These devices potentially have an edge over traditional techniques as, via automation, they reduce human error and require low sample volumes, resulting in the rapid, high-throughput, cost-efficient and reproducible separation of bioparticles.

Hitherto, within microfluidic devices bioparticles are separated using one of three general principles, namely: size discrimination such as in sieving techniques; hydrodynamic laminar flow separation; and non-inertia force fields such as in di-electrophoresis, acoustic radiation and magnetic field. However, the main separation criteria for all these varying methods is the spherical natured of the bioparticles (i.e. the bioparticles are considered as spherical). This dependence on the spherical nature of a bioparticle poses a great challenge for the separation of non-spherical bioparticles because the smallest dimension of non-spherical particles determines the cut-off size for the separation. Biological entities such as rod-shaped bacteria and disc shaped red blood cells (RBCs), to name but a few, have a disproportionate length or width (with respect to a spherical entity) which complicates the separation process that is ideally designed for spherical particles, as the narrowest width has to be considered for the separation criteria within the design parameters of microfluidic devices.

One clinically relevant non-spherical bioparticle is the red blood cell (RBC) and its separation from blood samples by “lab-on-a-chip” is important as it enables rapid point-of-care medical diagnostics for diseases. Soft-inertia techniques such as RBC flow margination and cross-flow filtration techniques have been used for RBC separation from whole blood.

RBC flow margination utilizes differences in size and deformability of RBCs, with respect to other circulating cells, for the separation. The RBCs migrate to the center of fluidic channels while the larger white blood cells (WBCs) migrate to the walls of the channel. Though this technique has high cell through-put, the efficiency ranges from ˜80% to ˜90% and depends on the flow rate and size of particle.

Cross-flow filtration techniques require crucially dimensions smaller than the length of the RBC (<7 μm) in order to separate RBC from the blood. RBCs separation efficiency using this technique ranges between 50% and 97%.

Deterministic lateral displacement (DLD) devices have also been used to separate RBCs from blood. However, the RBC is assumed to have a separation diameter spread of 2 μm-7 μm which reduces the efficiency of this technique and shows the randomness of the separation.

Unfortunately, the above discussed techniques only consider the minimum axis of the non-spherical RBC, thus impacting the effectiveness of the separation. Hence, in order to effectively separate such non-spherical biological entities for rapid medical diagnosis, new separation methods, which take into consideration the shape of the bioparticle, are required.

Microfluidic devices employ deterministic lateral displacement (DLD) to precisely control and manipulate fluids that are geometrically constrained within a small, typically sub-millimeter, space.

DLD has been established as an efficient technique for the continuous-flow separation of particles based on the spherical nature of particles and using conventional cylindrical pillars^{[1, 2, 3]}. However, typically the shape of the particles has not been taken into account using conventional DLD devices.

Some efforts have been made to change the post shape of DLD to enhance its critical separation diameter^{[4,5]}. Loutherback et al.^{[4,5]} have demonstrated that by using triangular pillars, the flow profile becomes asymmetric, resulting in a reduced critical diameter as compared with conventional DLD. However, this improvement does not address the varying critical diameter of a non-spherical particle. Sugaya et al.^{[6]} have also observed that by rotating non-spherical particles at the T-junction in a hydrodynamic filtration device, separation of non-spherical particles based on its longer dimension can be achieved. However, it is limited to a single flipping event of a non-spherical particle at the T-junction, which determines the success or failure of the separation process.

We therefore describe herein a method that takes into account the shape of non-spherical particles. We have hypothesized that inducing rotations of non-spherical particles will increase the effective size of separation of the particles. Without wishing to be constrained by theory or explanation, we consider that by leveraging on the rotation of a non-spherical particle we are able to ignore the narrowest width and instead mimic a spherical particle based on its greatest length.

### STATEMENTS OF INVENTION

According to a first aspect of the invention there is provided in, or for use in, a microfluidic device at least one pillar comprising, in cross-section, at least one particle abutment surface and an adjacent space that indents said pillar, or an adjacent groove that indents said pillar, to accommodate said particle.

In a preferred embodiment of the invention said cross-section of said pillar is selected from the group comprising: I-shaped, C-shaped, J-shaped, W-shaped, V-shaped, T-shaped, L-shaped, E-shaped and anvil-shaped.

In yet a further preferred embodiment of the invention said space or groove is bounded by either a linear or a curvilinear surface.

The purpose of the pillar is to induce rotation in particles flowing in the said device and so it is characterized by having:
1. An abutment surface or an edge which can act as a means to induce a rotation and so allow particles to rotate. The said surface or edge can have various designs including sharp or rounded.
2. A space or groove to accommodate the induced particle rotation: the pillar indentation ideally has enough space to accommodate the rotation of the particle. The space or groove can also have various designs. It can be curved or angled.

Overall, the pillar has a shape able to change the fluid profile around itself, so that a particle can experience a differential force, ideally across its length, which results in a net torque on it to induce rotation.

Preferably, said cross-section of said pillar is I-shaped and comprises a pair of oppositely positioned curvi-linear surfaces, ideally these surfaces provide, in cross-section, the central element of the I-shaped pillar thus connecting with the two cross-membered ends of the I-shaped pillar, alternatively all the surfaces of said pillar are linear, ideally the outer abutment surfaces may be rounded or angular.

Preferably, said cross-section of said pillar is C-shaped and comprises at least a single, or at least a pair of, curvi-linear surface(s), ideally this/these surface(s) define, in cross-section, the central space or groove of the C-shaped pillar and further said opposite outer abutment surfaces may ideally be rounded or angular.

Preferably, said cross-section of said pillar is J-shaped and comprises at least one linear and/or curvi-linear surface which in cross-section provides the central element of the J-shape and the lower hooked element, ideally the outer abutment surfaces may be rounded or angular.

Preferably, said cross-section of said pillar is W-shaped and comprises at least one, or a plurality of, linear and/or curvi-linear element(s) arranged in a W-shape with adjacent spaces or grooves there between, ideally the outer abutment surfaces may be rounded or angular.

Preferably, said cross-section of said pillar is V-shaped and comprises at least one, or a pair of oppositely positioned, linear and/or curvi-linear element(s) arranged in a V-shape with an adjacent space or groove there between, ideally the outer abutment surfaces may be rounded or angular.

Preferably, said cross-section of said pillar is T-shaped and comprises a pair of oppositely positioned curvi-linear surfaces, ideally these surfaces provide, in cross-section, the central element of the T-shaped pillar thus connecting to an upper cross-membered end of the T-shaped pillar, alternatively all the surfaces of said pillar are linear, ideally the outer abutment surfaces may be rounded or angular.

Preferably, said cross-section of said pillar is L-shaped and ideally comprises at least one linear and/or curvi-linear surface, ideally this surface provides, in cross-section, one of the two limbs of the L-shape pillar thus connecting to another limb of the L-shaped pillar, ideally the outer abutment surfaces may be rounded or angular.

Preferably, said cross-section of said pillar is E-shaped and comprises at least one or a plurality of linear and/or curvi-linear element(s) arranged in an E-shape with adjacent spaces or grooves there between, ideally the outer abutment surfaces may be rounded or angular.

Preferably, said cross-section of said pillar is anvil-shaped and comprises a pair of oppositely positioned curvi-linear surfaces, ideally these surfaces provide, in cross-section, the central element of the anvil-shaped pillar thus connecting to an upper and lower cross-membered end of the anvil-shaped pillar, ideally the outer abutment surfaces may be rounded or angular.

In yet a further preferred embodiment of the invention there is provided in, or for use in, a microfluidic device a plurality of said pillars, moreover, said pillars are arranged in an array. Preferably said pillars in said array are arranged such that along at least one selected axis said pillars are aligned. Additionally or alternatively, said pillars in said array are arranged such that along at least one selected axis said pillars are staggered.

Those skilled in the art will appreciate that pillars of the same shape may be used in said array. Alternatively, pillars having different shapes may be used in said array, thus the invention extends to the combination of different shaped pillars in an array including any selected combination of shapes provided in any selected configuration or pattern.

Those skilled in the art will appreciate that the combination and/or orientation of said pillars in an array may be selected to best maximise the purpose of the pillars i.e. to induce rotation in particles flowing thereby and/or facilitate the separation of particles.

The following arrays represent exemplary embodiments of preferred arrays.

In yet a further preferred embodiment of the invention there is provided in, or for use in, a microfluidic device a plurality of I-shaped pillars. Moreover, in a preferred embodiment said I-shaped pillars are arranged in an array, most preferably said array is such that along at least one selected axis said pillars are aligned such that said surfaces of adjacent I-shaped pillars provide a rectangular, circular or elliptical space through which fluid can flow.

In yet a further preferred embodiment of the invention there is provided in, or for use in, a microfluidic device a plurality of T-shaped pillars. Moreover, in a preferred embodiment said T-shaped pillars are arranged in an array, most preferably said array is such that along at least one selected axis said pillars are aligned such that said surfaces of adjacent T-shaped pillars provide a rectangular, circular or elliptical space through which fluid can flow. More preferably, alternate rows of said T-shaped pillars are inverted.

Additionally or alternatively, in yet a further, preferred embodiment of the invention there is provided in, or for use in, a microfluidic device a plurality of I-shaped pillars, wherein said pillars are arranged in an array whereby along at least one selected axis said pillars are staggered such that the cross-membered ends of adjacent I-shaped pillars are staggered so providing a space which requires lateral movement of particles flowing there through.

Additionally or alternatively, in yet a further preferred embodiment of the invention there is provided in, or for use in, a microfluidic device a plurality of T-shaped pillars, wherein said pillars are arranged in an array whereby along at least one selected axis said pillars are staggered such that the cross-membered ends of adjacent T-shaped pillars are staggered so providing a space which requires lateral movement of particles flowing there through.

Additionally or alternatively, in yet a further preferred embodiment of the invention there is provided in, or for use in, a microfluidic device a plurality of C-shaped pillars, wherein said pillars are arranged in an array whereby along at least one selected axis said pillars are staggered so providing a space which requires lateral movement of particles flowing there through.

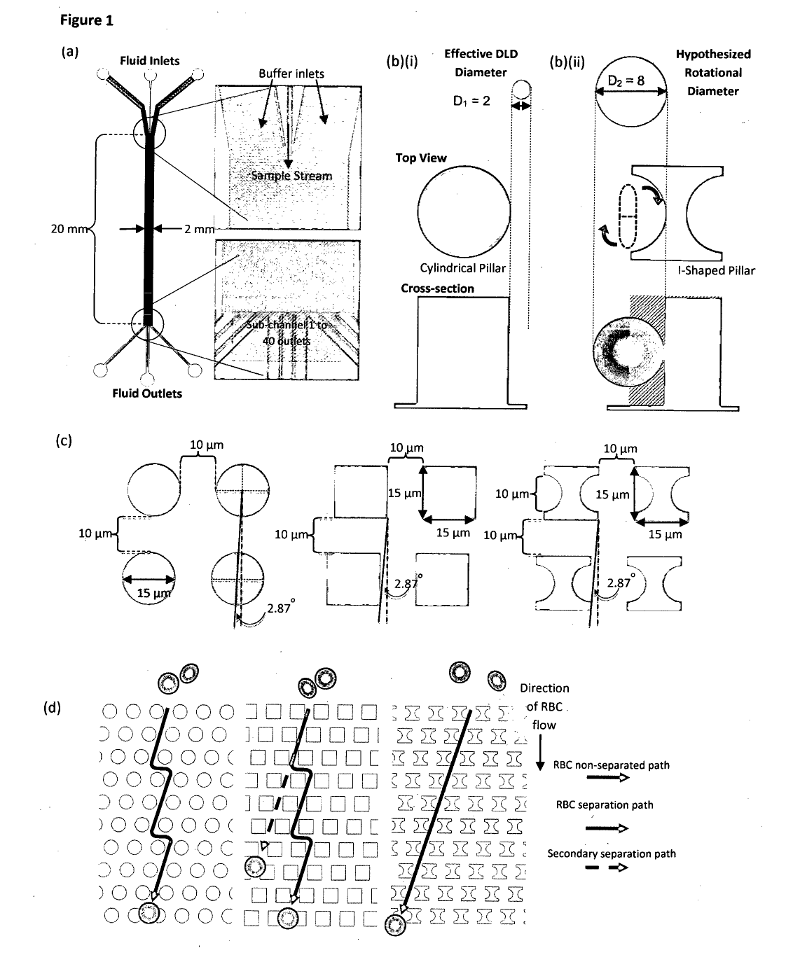

We have therefore designed novel pillars, in the example presented as an I-shape, to induce the rotation of non-spherical particles flowing in a laminar stream through a separation device, shown in 1(a). The novel pillar shape and principle is schematically explained in FIG. 1(b) with the example of a disc shaped particle. The effective particle separation diameter of a particle within a laminar flow, flowing through a collimated pillar gradient array has been extensively studied for traditional DLD and can be calculated based on known pillar array parameters.^{[4, 10]}. In the case within FIG. 1(b)(i) the DLD diameter of particle to be separated would be D₁. In contrast, the rotating disc-shaped particle in FIG. 1(b)(ii) would have a maximum rotational diameter of D₂ which is much greater than D₁. The I-shaped pillar has two cross-membered ends or protrusions (abutment surfaces) which induce rotation and a middle groove, formed by said curvi-linear surfaces, to accommodate the rotation of any non-spherical particles. Thus, by inducing rotation, our novel pillars can increase the effective size/diameter of particles and can separate the diverse shapes and sizes of biological samples more efficiently compared to conventional methods.

According to a second aspect of the invention there is provided a method for separating non-spherical particles in a fluid comprising:

a) providing in a microfluidic device a plurality of pillars comprising, in cross-section, at least one particle abutment surface and an adjacent space that indents said pillar, or an adjacent groove that indents said pillar, to accommodate said particle and further wherein said pillars are arranged in an array such that adjacent pillars define a space through which a fluid can flow;

b) causing a fluid to flow through said device;

c) making particles in said fluid rotate in at least one direction as they flow around said pillars;

d) collecting separated particles as they leave said array.

Additionally or alternatively, in a preferred embodiment of the invention or a third aspect of the invention there is provided a method for separating non-spherical particles in a fluid comprising:

a) providing in a microfluidic device a plurality of pillars comprising, in cross-section, at least one particle abutment surface and an adjacent space that indents said pillar, or an adjacent groove that indents said pillar, to accommodate said particle and further wherein said pillars are arranged in an array such that adjacent pillars define a space through which a fluid can flow and wherein pillars in either adjacent rows and/or columns are staggered so defining a space which requires lateral movement of particles flowing there through;

b) causing a fluid to flow through said device;

c) making particles in said fluid rotate in at least one direction as they flow around said pillars;

d) collecting separated particles as they leave said array.

Those skilled in the art will appreciate that, in part, it is the geometry of the pillars that causes the non-spherical particles to rotate when flowing through said device.

According to a fourth aspect of the invention there is provided a diagnostic method involving the separation of selected cells from a sample involving either of, or both, of the above methods for separating non-spherical particles in a fluid.

Indeed, the invention has application in at least the following applications.

Blood Components Separation

It is known that RBCs are disc shaped and highly deformable. This makes separation of RBC much harder than round bodies such as white blood cells. Efficient and rapid separation of RBCs from white blood cells, platelets and plasma would allow immediate benefits for the possible detection of diseases, bio-markers in plasma and infection. This will facilitate diagnostics and treatment.

Bacteria Separation from Fluids

Bacteria can exist in all fluid systems on earth from sewers, rivers, saliva and urine to blood. These bacteria have a wide variety of shapes ranging from rod-like, spiral and spherical. Current techniques of bacterial separation and testing involve traditional growth culture to separate and identify them. This process takes at least a day. Being able to separate bacteria rapidly will definitely facilitate more efficient detection and isolation processes.

Parasitic Separation

Water borne parasites such as worms and tiny micro-organisms can potentially cause harm to humans and animals. These parasites are predominately non-spherical in shape. Effective separation and detection processes are needed. The novel I-shape designs described herein would be effective in the separation of these parasites.

Algae Testing in Water

Algae come in various shapes and sizes. These algae can contaminate water sources or cause harm to humans or the environment. Separation of algae based on shapes and size can provide rapid detection and analysis of water samples.

Separating Viruses from Body Fluids

Virus separation and detection offers significant opportunities for the development of medical diagnostic devices. Nano-fabrication techniques can be used to develop I-shaped pillars for separation and detection of viruses.

Ideally said invention is used for the separation of bioparticles, although it can be used to separate any shape of particles. Although it confers greater advantages for separation of non-spherical particles, it can also be used for separation of spherical particles from other particles or from the fluid in a fluid system. These non-spherical particles include, without limitation, disc-shaped RBCs and rod-shaped bacteria, or indeed, any particle which has a disproportionate length or width.

In the claims which follow and in the preceding description of the invention, except where the context requires otherwise due to express language or necessary implication, the word “comprises”, or variations such as “comprises” or “comprising” is used in an inclusive sense i.e. to specify the presence of the stated features but not to preclude the presence or addition of further features in various embodiments of the invention.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The invention will now be described by way of example only with reference to the following figures and tables:

FIG. 1 shows a Schematic of a device in accordance with the invention: FIG. 1(a) shows the schematic of a microfluidic device where the output channels are divided into 40 sub-channels for the quantification of the separation process. The fluid mechanics underpinning our invention are illustrated in FIG. 1(b) which shows the difference between the conventional DLD pillars in (b)(i) and I-shaped DLD in (b)(ii). It is shown that the rotation of a RBC caused by an I-shaped pillar will increase its rotational diameter to a maximum of 8 μm which is the diameter of the RBC. FIG. 1(c) depicts the dimensions and parameters of the DLD pillars of different shapes. FIG. 1(d) depicts the projected paths of RBCs as they flow within the respective devices of FIG. 1(c) with different pillar-shapes;

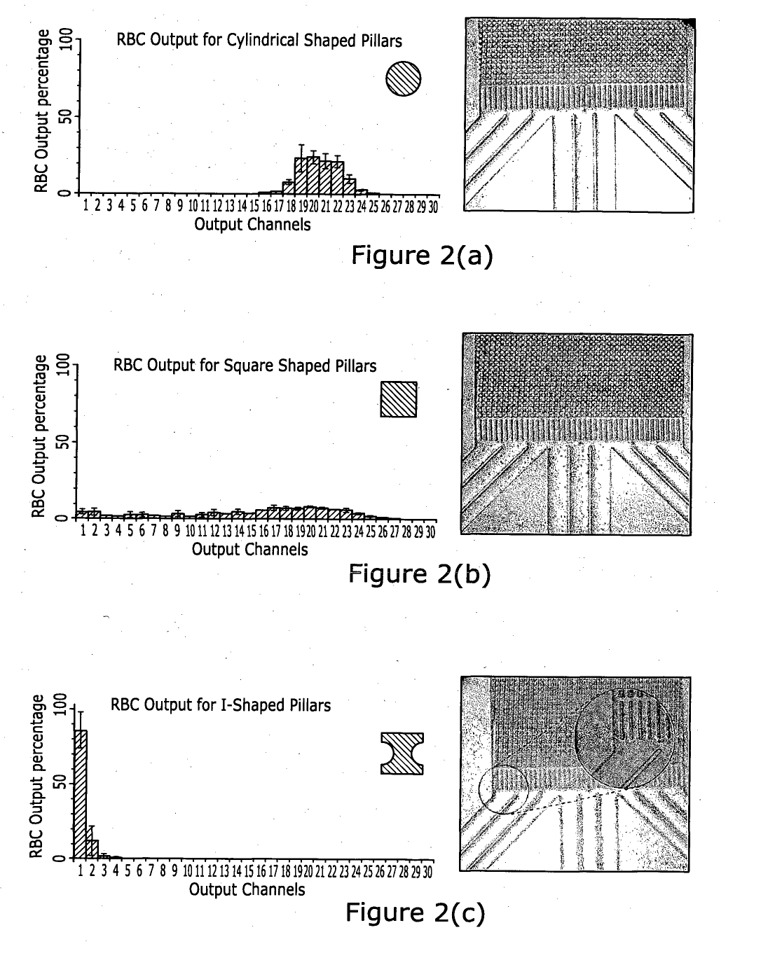

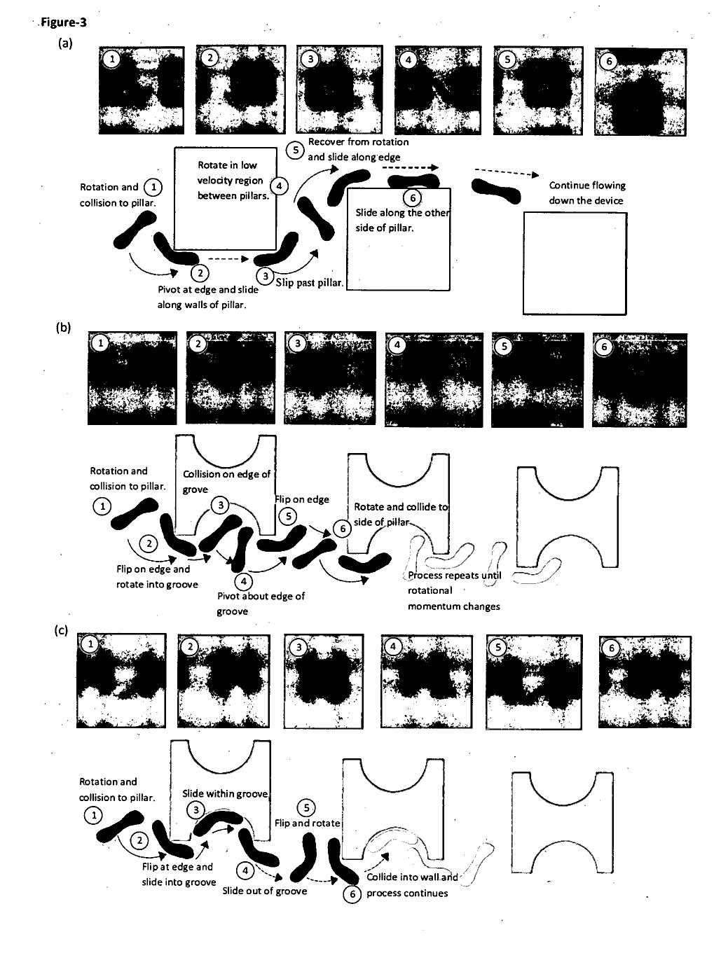

FIG. 2 shows RBC output separation distribution ratio for cylindrical, square and I-shaped pillars. The respective results of the RBC separation for circular pillars in (a), control square pillars in (b) and I-shaped pillars in (c) are shown in the graphs. The graphs are plotted by the percentage ratio of total RBC at the output channels and the area under the graph is 1. The screen capture of the output regions are shown on the right of the respective graphs. FIG. 3(c) also shows the magnified region of the output channels 1 to 5;

FIG. 3 shows Tracking RBC movements: this Figure is a compilation of the major flow movements of RBC around square pillars in (a) and the I-shaped pillars in (b) and (c). (a) shows the primary movement of RBC around square shaped pillars in 6 steps as captured from video screen shots as it flows down the non-separated path. (b) and (c) depicts RBC separation paths with two types of observed rotational movements in the DLD device with I-shaped pillars;

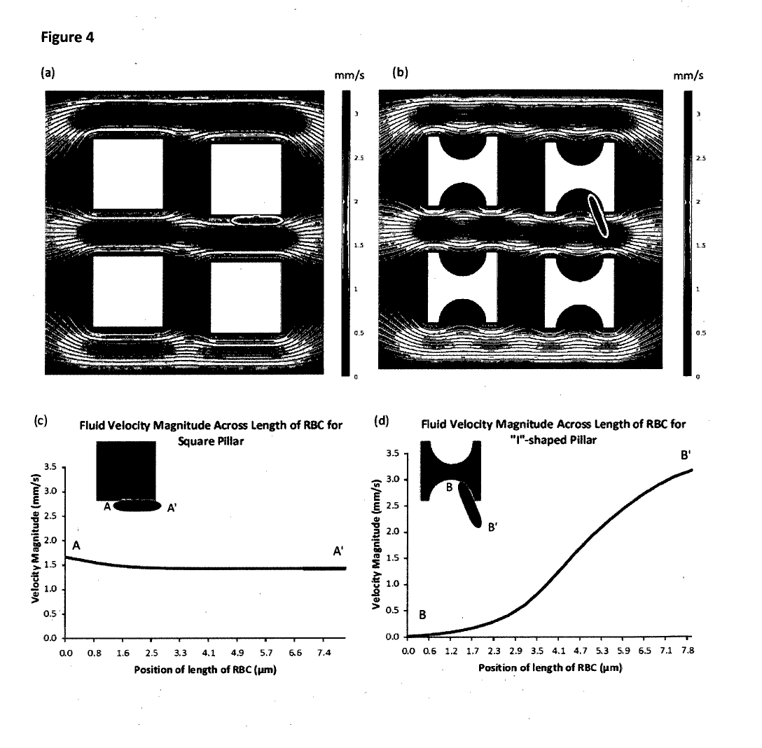

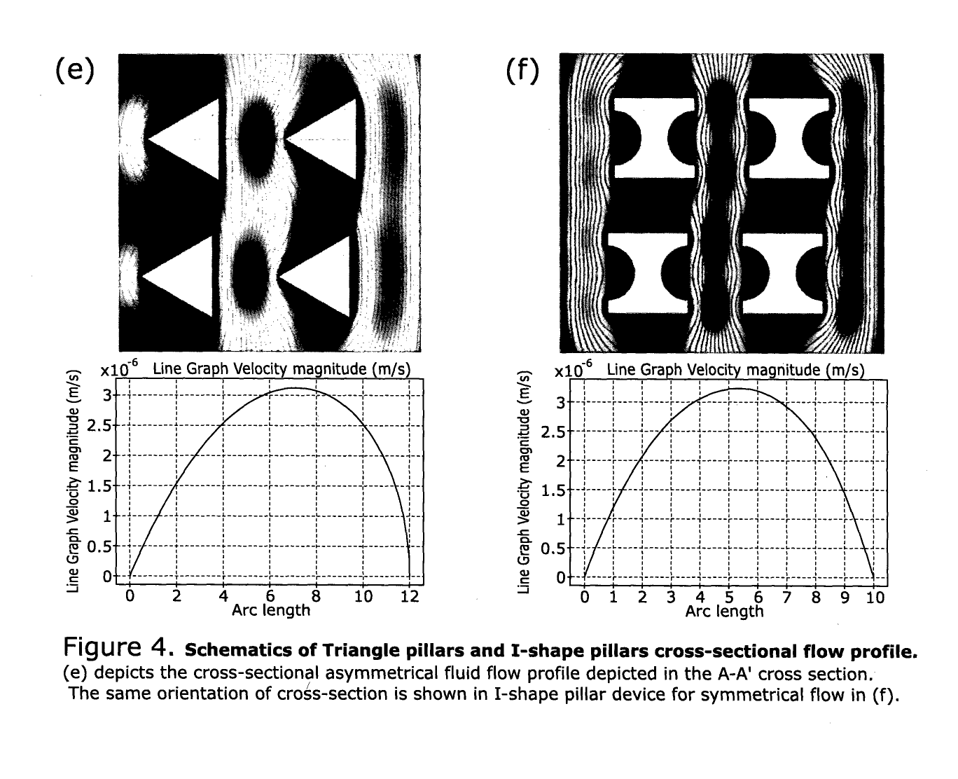

FIG. 4 shows a Fluid-flow simulation: COMSOL Multiphysics was used to simulate the fluid flow profiles for a DLD device with square pillars in (a) and I-shaped pillars in (b). The super-imposed elongated rod shaped figure in light pink is used to represent the position of a RBC in the fluid flow experiencing different velocities across the RBC body;

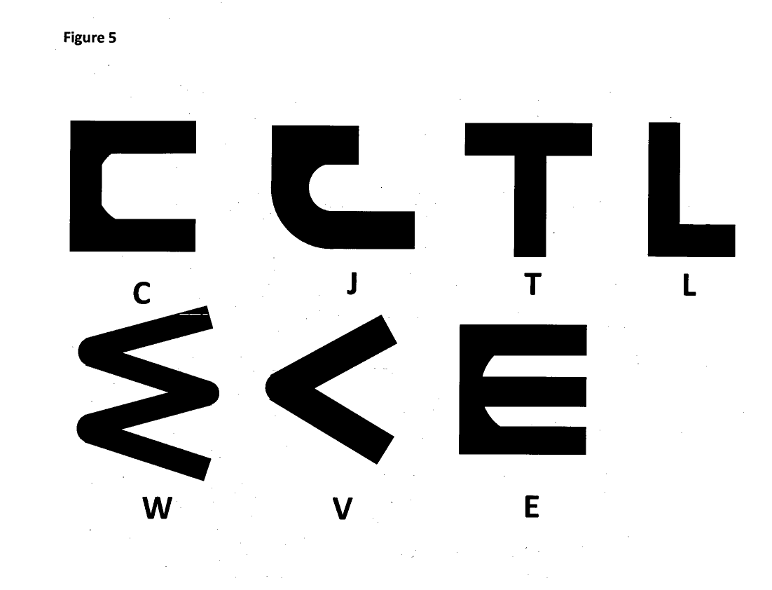

FIG. 5 shows further examples of different pillar cross-sectional shapes that can induce rotation of non-spherical particles and so can allow their separation in a similar way as the “I” shaped pillar, and its array, described herein;

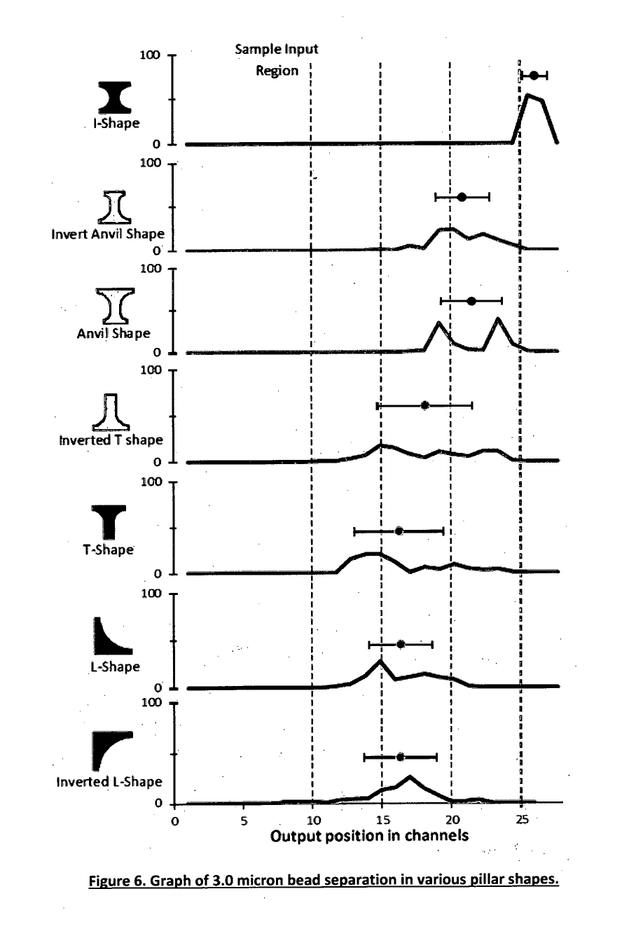

FIG. 6 shows a graph of 3.0 micron bead separation in various pillar shapes;

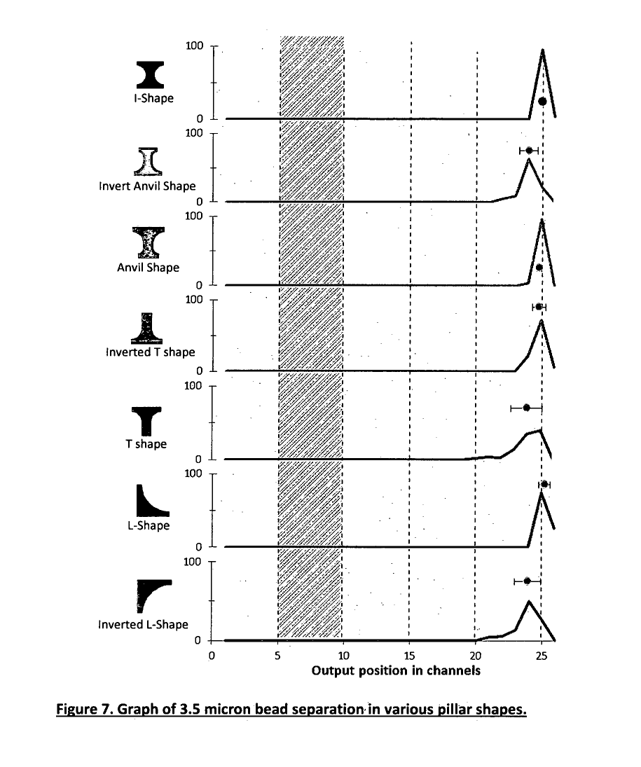

FIG. 7 shows a graph of 3.5 micron bead separation in various pillar shapes;

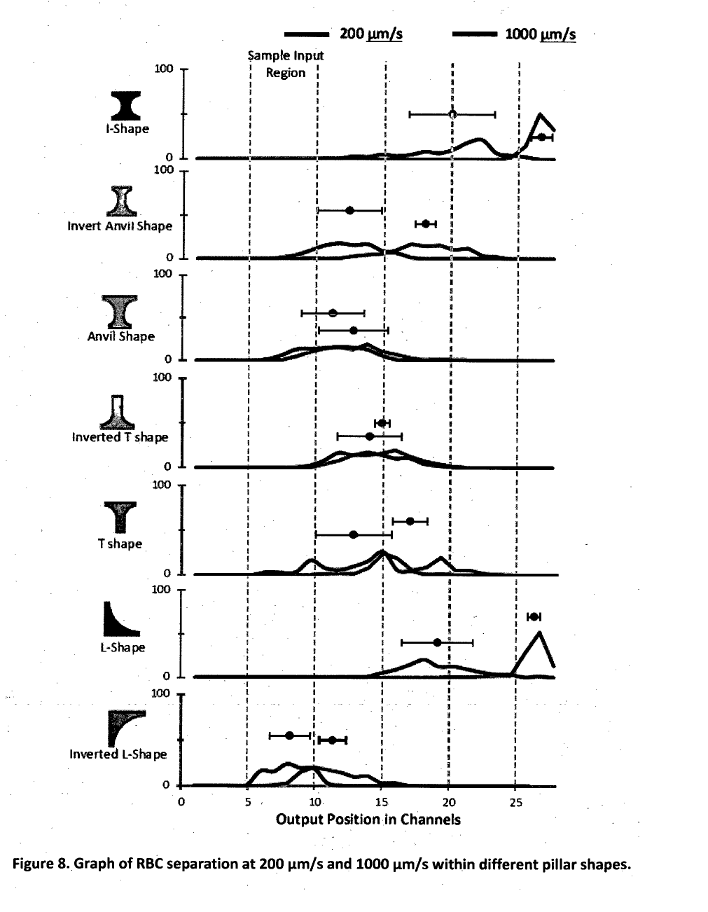

FIG. 8 shows a graph of RBC separation at ˜200 μm/s and ˜1000 μm/s within different pillar shapes;

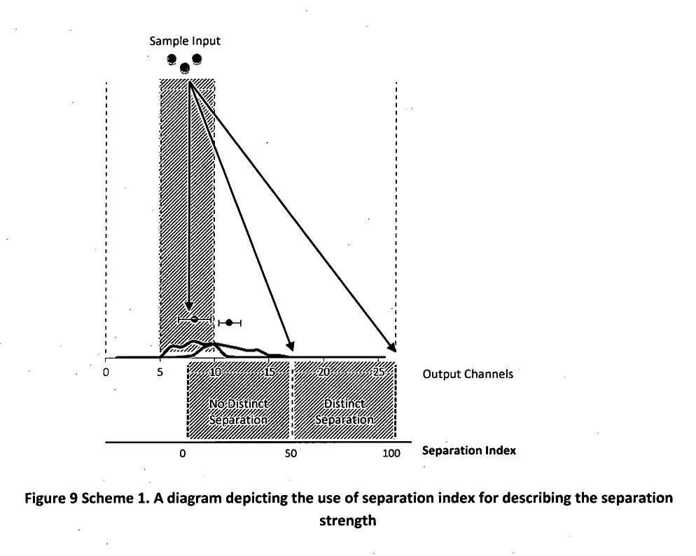

FIG. 9 shows a diagram depicting the use of separation index for describing the separation strength;

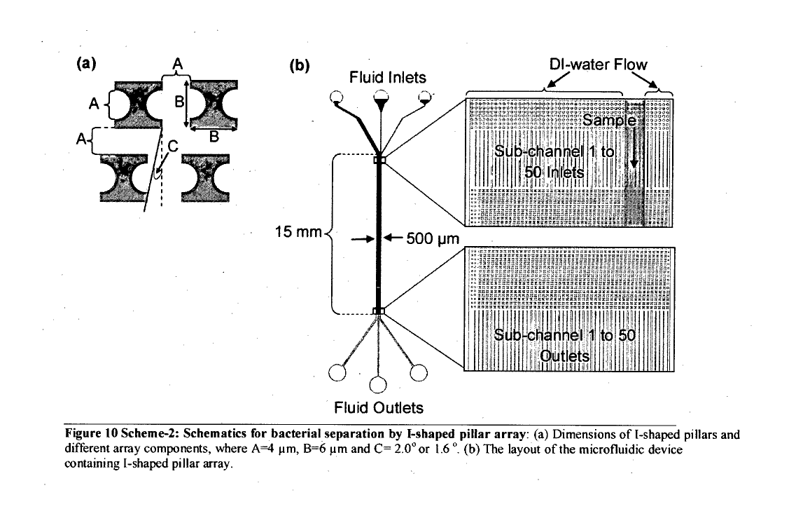

FIG. 10 shows the schematics for bacterial separation by I-shaped pillar array: (a) Dimensions of I-shaped pillars and different array components, where A=4 μm, B=6 μm and C=2.0° or 1.6°. (b) The layout of the microfluidic device containing I-shaped pillar array;

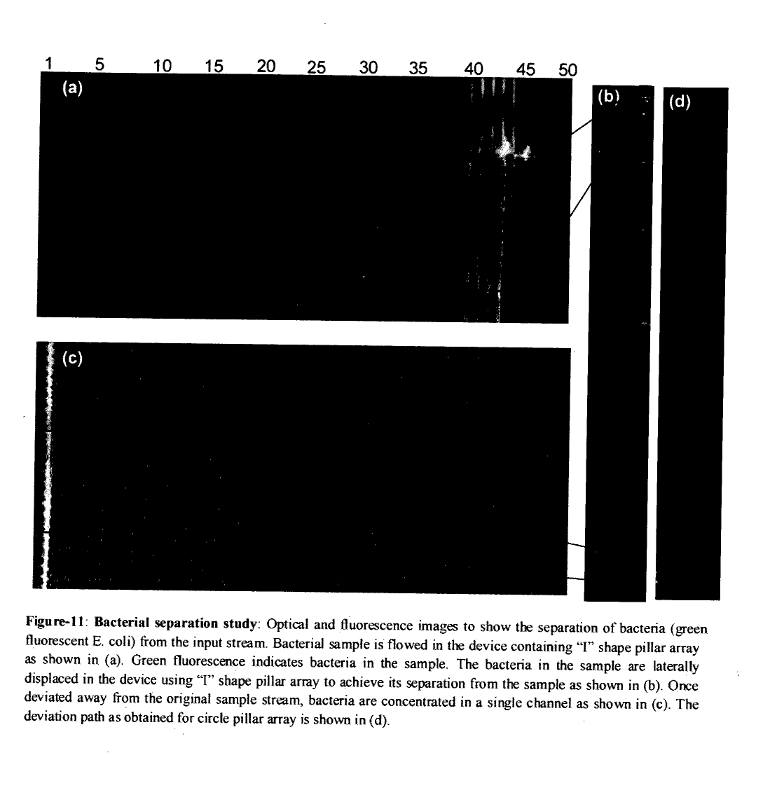

FIG. 11 shows a Bacterial separation study: Optical and fluorescence images to show the separation of bacteria (green fluorescent E. coli) from the input stream. Bacterial sample is flowed in the device containing “I” shape pillar array as shown in (a). Green fluorescence indicates bacteria in the sample. The bacteria in the sample are laterally displaced in the device using “I” shape pillar array to achieve its separation from the sample as shown in (b). Once deviated away from the original sample stream, bacteria are concentrated in a single channel as shown in (c). The deviation path as obtained for ‘control’ circle pillar array is shown in (d);

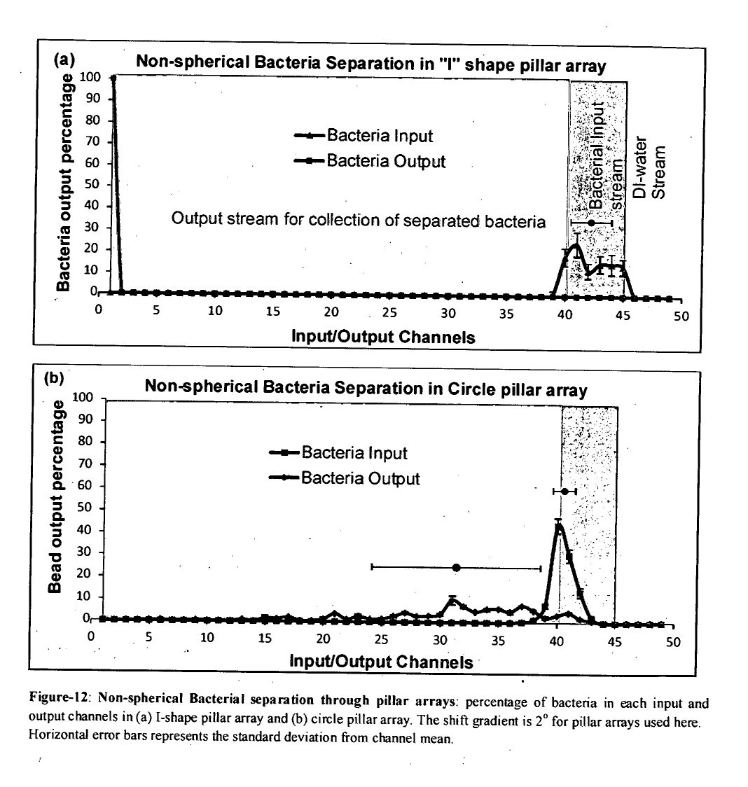

FIG. 12 shows non-spherical Bacterial separation through pillar arrays: percentage of bacteria in each input and output channels in (a) I-shape pillar array and (b) circle pillar array. The shift gradient is 2° for pillar arrays used here. Horizontal error bars represents the standard deviation from channel mean;

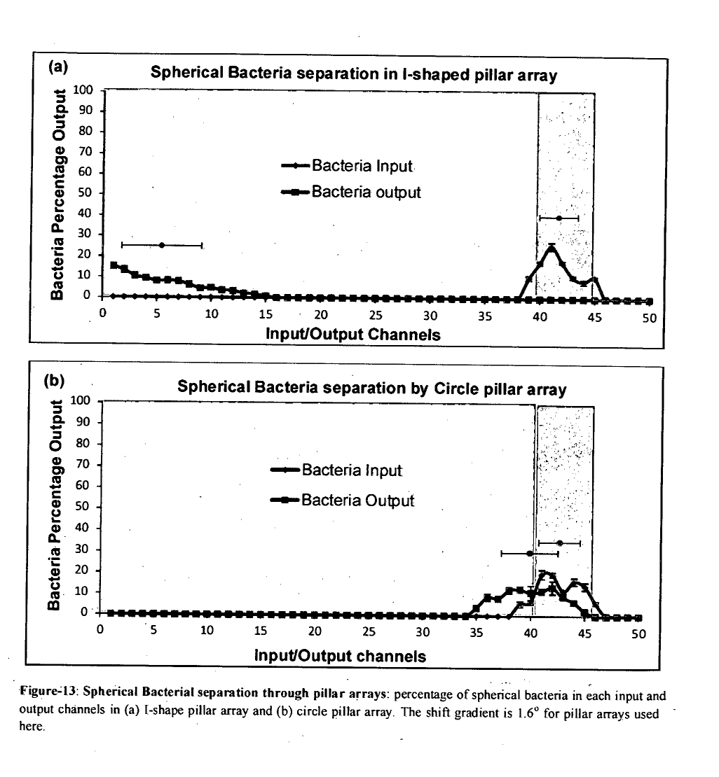

FIG. 13 shows Spherical Bacterial separation through pillar arrays: percentage of spherical bacteria in each input and output channels in (a) I-shape pillar array and (b) circle pillar array. The shift gradient is 1.6° for pillar arrays used here;

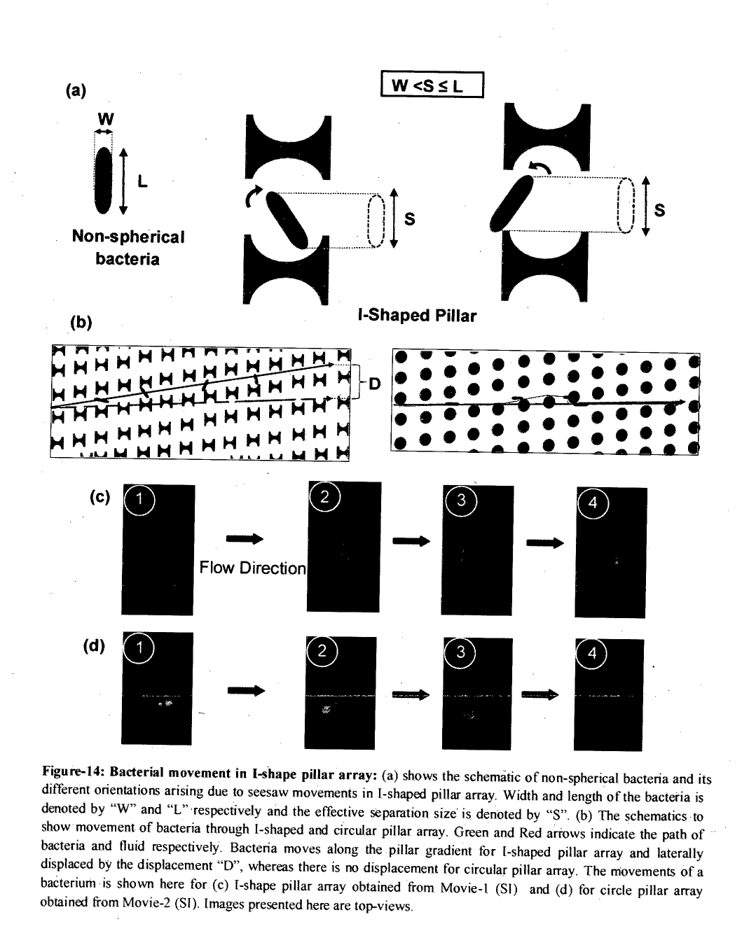

FIG. 14 shows bacterial movement in I-shape pillar array: (a) shows the schematic of non-spherical bacteria and its different orientations arising due to see-saw movements in I-shaped pillar array. Width and length of the bacteria is denoted by “W” and “L” respectively and the effective separation size is denoted by “S”. (b) The schematics to show movement of bacteria through I-shaped and circular pillar array. Green (upper) and Red (lower) arrows indicate the path of bacteria and fluid respectively. Bacteria moves along the pillar gradient for I-shaped pillar array and are laterally displaced by the displacement “D”, whereas there is no displacement for a circular pillar array. The movements of a bacterium is shown here for (c) I-shape pillar array obtained from Movie-1 (SI) and (d) for circle pillar array obtained from Movie-2 (SI). Images presented here are top-views;

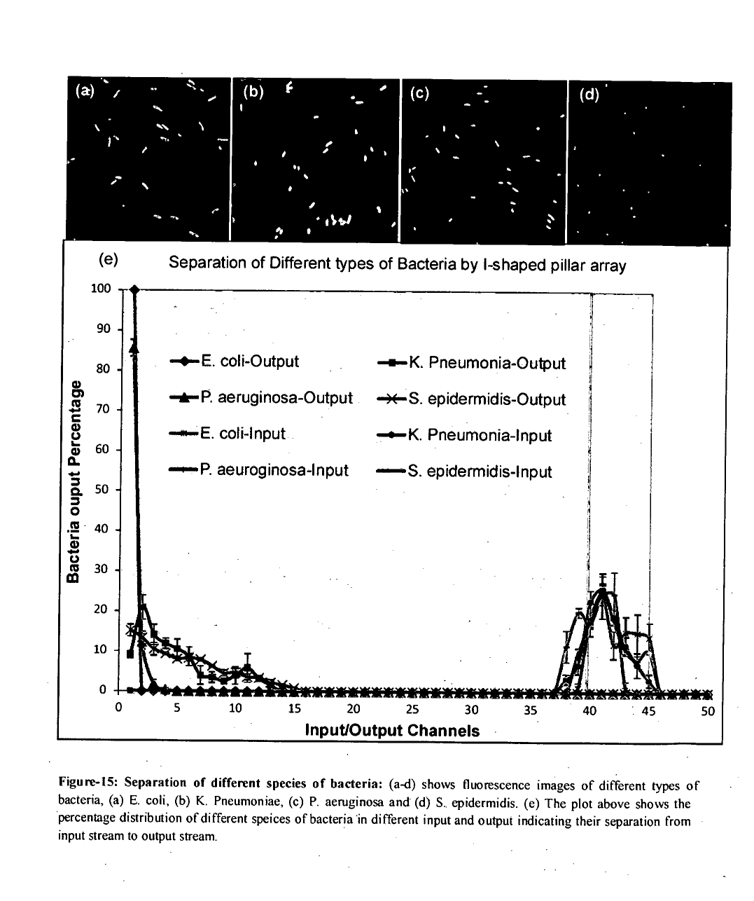

FIG. 15 shows the separation of different species of bacteria: (a-d) shows fluorescence images of different types of bacteria, (a) E. coli, (b) K. Pneumoniae, (c) P. aeruginosa and (d) S. epidermidis. (e) shows the percentage distribution of different species of bacteria in different input and output channels indicating their separation from input stream to output stream; and

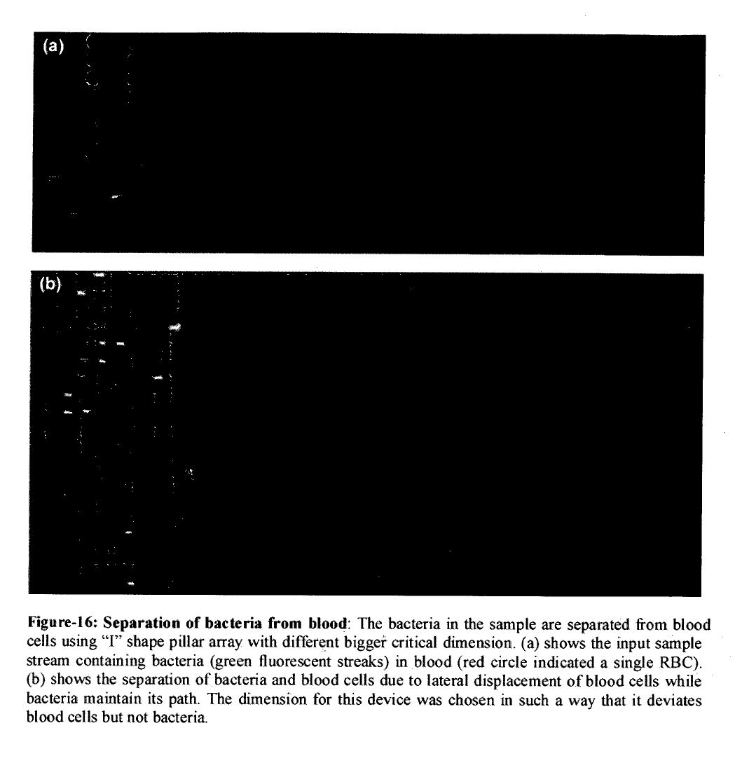

FIG. 16 shows the separation of bacteria from blood: The bacteria in the sample are separated from red blood cells by removing the blood using an “I” shaped pillar array with a different i.e. larger critical dimension suited for red blood cells.

(a) shows the input sample stream containing bacteria (green fluorescent streaks) in blood (red circle indicates a single RBC). (b) shows the separation of bacteria and blood cells due to lateral displacement of blood cells while the bacteria maintain their path. The dimension for this device was chosen in such a way that it deviates blood cells but not bacteria.

Table 1 shows tests undertaken on different shaped pillars in either an upright or inverted array within a DLD device.

Table 2 is a summary of data showing the converted separation index: An index of more than 50 is highlighted (in cyan). The index is based on the mean separation of the particles within various devices.

The invention will now be described by way of example only with reference to various shaped pillars and in particular an I-shaped pillar, although those skilled in the art will appreciate the invention may also be practised using any of the pillars described herein.

### METHODS

Illustration of the Invention Having Regard to RBC Monitoring

Device Fabrication The silicon microfluidic device was fabricated on a silicon wafer using standard lithographic techniques. A SUSS MA8 lithography machine was used to transfer the device design in FIG. 1(a) from a glass mask to a positive photo resist (AZ5214E) coated on the silicon surface. The wafer was placed in an Oxford 180 deep reactive ion etching machine to plasma etch the channels for the device. Piranha solution was used to remove any remaining photoresist on the wafer surface. A thin sheet of poly-dimethylsiloxane (PDMS) was fabricated and the inlet and outlet holes were punched before the PDMS was bonded over the silicon device using oxygen plasma. The device design shown in FIG. 1(a) comprises three inlet channels, a DLD main channel of 2 cm long and three outlet channels divided into 40 sub-channels for characterization of device separation efficiency. There are a total of three DLD designs as shown in FIG. 1(c), namely circle/cylindrical pillar, square pillar and the I-shaped pillar. Moreover, further designs as shown in FIGS. 6-8 were also made in accordance with the above method.

Experimental Procedure

The inlet tubes were attached to the final device and washed with 1% w/v pluronic F127 (Sigma, Singapore) for 30 mins. This is for surface passivation to prevent any form of non-specific attachment of the sample. A blood sample was extracted from a finger prick and diluted 10 times in 1×PBS buffer (Sigma, Singapore). The diluted blood sample was driven using a syringe pump at a flow rate of 0.4 μl/min while the two PBS buffer streams were at 1 ul/min each.

High-speed video footages on the motion of RBCs was captured by Phantom Miro M310 at 1000 frames per second. These raw videos were analysed on the computer and results were tabulated and shown in FIGS. 2 and 3. The output data was compiled by counting the total number of cells at various output channels. Screen shots were extracted to view the motion and position of RBCs for its interaction with the pillars.

Result and Discussion

The novel I-shape design is hypothesized to induce rotations of non-spherical particles in order to increase its effective separation diameter. FIG. 1(d) shows a comparison of RBC separation paths between circle pillars, square pillar and I-shaped pillars. All three pillar types in FIG. 1(c) are designed with exactly the same DLD dimensions of 10 μm gap size, pillar shift gradient of 2.86° and maximum pillar length of 15 μm. We wanted to compare how the conventional cylindrical pillars fared with the sharp edges of square pillar and the proposed and I-shaped pillar.

In all three pillar types, fresh blood was infused into the device using a syringe pump at a rate of 0.4 μl/min. The buffer streams sandwich the sample stream with flow velocities of 1 μl/min each. At these flow rates, the input distribution of RBCs for the sample stream spreads from channel 15 to channel 26. In order to quantify the effect of separation, RBCs at each sub-channel output is counted and is tabulated as a ratio of the total RBCs calculated. There are 40 output sub-channels identified as channel 1 to 40 starting from left to right shown in FIG. 1(a). However, only channels 1 to 30 are tabulated in the graphs shown in FIG. 2 as there are no RBCs flowing in channels 31 to 40 due to the buffer stream on the right side of the graph. The results in FIG. 2 concur with the schematics shown in FIG. 1(d) and also clearly show the RBC separation at the output regions with minimal RBC separation for cylindrical pillars in FIG. 2(a), scattered distribution of RBC for square pillars in FIG. 2(b) while FIG. 2(c) shows a highly effective and focused separation for and I-shaped pillars.

Three sets of video output data were acquired using a high-speed camera and the ratio of RBCs at the output were tabulated into the graphs. RBC separation is not observed in the cylindrical pillar array. The final output shown in FIG. 2(a) depicts the RBC output distribution ratio to be between channels 15 to 25 which do not deviate from the original sample distribution of channels 15 to 26. The distribution peaked at ˜24% in channel 20. The critical diameter of the cylindrical pillars is calculated to be 2.7 μm, which is larger than the 2 μm width of the RBC. For DLD separation to be effective, the particle to be separated has to be larger than the critical diameter. In this case, the RBC's narrowest width is smaller than the critical diameter resulting in minimal separation which can be seen in the distribution of RBC ratio in FIG. 2(a) and its inability to separate the RBC.

From FIG. 2(b), the RBC separation in a square pillar array shows a widely distributed RBC output ratio ranging from channels 1 to 26. The peak RBC output ratio is ˜8% at channel 20. Though the majority of the RBCs are distributed near the central regions (between channels 15 to 25), there are RBCs that deviated all the way to channel 1. Comparatively, square pillars have an effect on RBC separation comparable to cylindrical pillars with the same DLD parameters such as gap size (10 μm) and pillar array gradient (2.860). It is important to note that the RBCs do rotate in the DLD square pillar array. From FIG. 3(a) we can see that the square edge of the pillar could have caused the RBC to flip and rotate. This could have an effect on the separation causing a wide spread of RBC distribution ratio shown in FIG. 2(a). While the interesting results in square pillars require further investigation, our main focus is to use it as a control for I-shaped pillars. The distinct spread and scattering of RBC distribution for square pillars shows that the square DLD pillar array has an effect on RBC separation compared to cylindrical pillars but not effective enough to ensure an efficient separation.

In contrast to square and cylindrical pillars, I-shaped pillars are extremely effective in separating non-spherical particles, such as RBCs. The output graph in FIG. 2(c) shows complete separation of RBC in channels 1 to 4, deviating away from its original RBC input distribution of channels 15 to 26. Also, the peak distribution of ˜86% in channel 1 is distinctly greater than peak distribution for square (˜8%) and circle pillars (˜24%) DLD devices. The slight spread to channels 2 and 3 is due to slight overcrowding of RBC in channel 1 which spill over to the other channels. The magnified view shows a snap shot of the 100% separated RBC stream in the output channel 1. This focused stream of RBC separation clearly shows the effectiveness of I-shaped pillars compared to the control square pillar array and the conventional cylindrical pillar array. Since the DLD pillar array gap size and gradient are fixed across the three pillar types, it would suggest that the effective separation size of RBCs in an I-shaped pillar array is greater than in a square pillar array and a cylindrical pillar array.

In order to confirm if the increase in efficiency is due to the increase in effective separation size induced by rotation of RBCs, the movements of RBCs in both square and I-shaped pillar arrays were captured and analyzed. Detailed schematics and screen shots of the motion of RBCs around the control square pillar array and I-shaped pillar can be seen in FIG. 3. FIG. 3(a) depicts the path of a RBC which does not get separated in a square pillar array. The RBC's movements follow a laminar flow path and flow length-wise close to the side of the pillars hence the effective diameter of the RBC is approximately 2 μm which is the width of the RBC. It is also noted that as it collides into the walls of the pillar in step 1, it deforms and conforms to the shape of the pillar, sliding along the walls. If the RBC does not slide well along the walls of the pillar, it might get displaced from its original laminar flow path (bumped) and get separated. This would result in a possible bumping and hence separation in the square pillar array, explaining the spread of RBCs throughout the output channels.

FIGS. 3(b) and 3(c) shows two observed motions of RBC as they flow past I-shaped pillars. These two figures depict the motion of a RBC that follows the gradient of DLD resulting in the final displacement from the original laminar flow path and hence separation at the output channels. FIG. 3(b) shows a bumping and tumbling motion while FIG. 3(c) shows RBC sliding motion along the sides of the pillar walls which is similar to the schematics shown for the RBC movement in square pillar array above. Though both RBC movements differ, the cross-membered I-shape protrusions act as two pivot points for the RBC to turn or rotate and the groove provides room for the RBC to flip and tumble within (step 1 and 4). This distinct difference in RBC movement compared to the square pillar array shows how a simple groove in the novel I-shape pillar design simply de-stabilizes the streamline flow of the RBC. Hence the I-shaped pillars have been shown to induce turning or rotations of RBCs resulting in a greater effective separating diameter.

Thus it can be seen that our mechanism for separation aims to induce rotation (fully or partially) and we have shown that the rotation and tumbling of disc shape RBCs in an I-shaped pillar DLD array results in a focused separation stream. This concept of rotation is also not limited to RBCs but can be applied to all-non-spherical entities such as, without limitation, other cells, deformable or otherwise, and micro-organisms such as, without limitation, bacteria.

Moreover, we have performed computational analysis on COMSOL Multiphysics platform for both the square pillar array and I-shaped pillar array and the triangular-shaped pillar array to study the fluid flow and velocity profile. For the computation of each device, we have set a minimum 2 by 2 pillar array and the initial flow velocity is set to 1 mm/s with 0 pressures at the outlets. All other boundary conditions were set the same for both models. The computational data in FIG. 4 shows the velocity and streamline profile for all devices. They have similar peak flow rates in red (away from pillars) and low flow rates in dark blue near the walls of the pillars while the dark lines are fluid stream-lines. It can be seen that square pillars in FIG. 4(a) have relatively constant and smooth flow profiles between the pillars, unlike I-shape pillars in FIG. 4(b) where the groove between pillars causes a disturbance in stream-line path. The super-imposed RBCs in both FIGS. 4(a) and (b) are placed in the same positions that can be seen in FIGS. 3(a) and (b). Clearly, the RBC in FIG. 4(a) does not experience as much variations in velocity across its length hence it flows along the streamline path along the sides of the wall. However, the RBC positioned in I-shape pillars experiences varying velocity fluid flow along its length. This variation of velocity flow results in the formation of a net moment acting on the RBC, causing it to turn or rotate. The double protrusions in each I-shape pillar either side of a pillar indent or groove create variations in fluid streamlines and velocities resulting in changing in moments, hence the observed RBC's rotation within this flow velocity field. In FIG. 4(e) the asymmetrical flow pattern caused by the triangular pillars is evident.

Conventionally, in order to compensate for the non-spherical shape of a bio-particle, current techniques would have to push the limits of their separation technology by focusing the separation criteria on the narrowest width of the non-spherical bio-particle. In contrast, we increase the effective separation diameter for non-spherical particles by emphasizing the greatest length, instead of the narrowest width, via induced rotation. By increasing the effective separation diameter of the non-spherical particle, the device can be more effective, smaller and simplify the fabrication techniques.

The Study of Different Shapes of Pillars with Curvi-Linear Design for DLD Separation

In the following studies a RBC is selected as the non-spherical particle as it is generally very difficult to separate because of its deformability as well as its unique disc shape, it is therefore an ideal test particle for representing non-spherical particles. Moreover, blood is also one of the most commonly separated biological materials in hospitals and clinics making it substantially important to effectively separate non-spherical particles from blood for rapid downstream analysis of the biological fluid.

Within pillars, we have explored and experimented on the various combinations of pillar protrusions (to induce rotations of non-spherical particles) and associated grooves (to accommodate the rotation of these particles). These combinations resulted in a greater understanding on how pillar shape affects the separation of non-spherical particles in a fluid. Table 1 shows the shapes of pillars we have explored and the various parameters used in our tests. Table 1 is to be read in conjunction with FIGS. 6-8.

All tests were performed using spherical beads of 3.0 and 3.5 microns in diameter as well as red blood cells with a disc diameter of approximately 8 μm and 2 μm in thickness. The results of the separation can be seen in FIGS. 6-8. As a result of these tests we devised a separation index system for ease of data comparison by normalizing the separation distance for all the experiments. The explanation of the separation index is depicted in FIG. 9 while the combined data showing the separation index of the various experiments can be seen in Table 2. Separations with indexes higher than 50 are considered good separations while separations with indexes less than 50 are considered weak separations.

From Table 2 and FIGS. 6-8, we can evidently see the positive effects of having a pillar with (in cross-section) a double protrusion and groove. The increase or double protrusion enables a more effective separation of non-spherical particles. For symmetrical flows, the greater the protrusion the better the separation of non-spherical RBCs, while for asymmetrical flow, the orientation of the protrusion is more critical for separation of non-spherical particles. Computational modelling of asymmetrical flow around triangular pillars can be seen in FIG. 4. Clearly there is a distinct difference in flow patterns between the two similar shaped but orientation varying pillars. The protrusions play a distinct role in modulating the flow and subsequently the RBC separation resulting in weaker separation in inverted L-shape and more distinct separation in L-shape.

These results show that controlling motion and separation of non-spherical particles is inherently complex with various flow parameters as well as particle motion involved.

From the pillars that have been explored, I-shaped pillars resulted in the best separation for both spherical and non-spherical particles.

Separation Index for Comparison of Efficiency Between Pillars

In order to compare the various separation results between different pillars, a separation index was used. The index is as standard for general comparisons of efficiency and separation quality between various devices. The strength and quality of separation is expressed in the magnitude of the index while the resolution is denoted in the standard deviation. The advantage of using an index is to have a standard method of comparison between various devices across all DLD experiments regardless of the number or length of output positions.

The formula for the index is as follow:

$$\frac{Mean Seperation Displacement}{Max Seperation Channels / Displacement} \times 100$$

$$\frac{\overline{X} - 7.5}{26 - 7.5} \times 100$$

X̅=the mean deviation of the sample stream as depicted in the graphs.

7.5 represents the theoretical average of the sample region which is the mid-point of

5 and 10 channels

26 represents the max possible channel deviation.

Hence, the index range from 0 (no deviation from sample stream) to 100 (Max deviation of sample stream). We also set 50 as the target for minimum separation requirements. For our current DLD setup, an index of less than 50 is not considered separation, while an index of 50 and above, separation can be considered distinct. Note that the deviation of the mean needs to be considered when the index is near 50. The greater the index, the better the separation strength.

Study of Bacterial Separation in I-Shaped Pillar Array

Current methods of diagnosing bacterial disease usually require the culture of bacteria this is time-consuming and requires trained technicians in well-equipped laboratories. Patient outcomes will improve with faster and more sensitive bacterial detection techniques based on the direct separation of bacteria from pathological samples. Current alternative bacterial separation techniques focus on the separation of spherical particles, these are not suitable for non-spherical bacteria, which includes most gram negative pathogens. We have investigated our preferred novel I-shaped pillar array design which we have discovered allows the effective separation of spherical as well as non-spherical bacteria. Briefly, this study is outlined below:

A. Device design for the I-shaped pillar array for bacterial separation: The new device was designed with different array parameters as shown in the Scheme-2, FIG. 10.

B. Separation of non-spherical bacteria using I-shaped pillar array: E. coli was chosen as the model non-spherical bacteria for this study. A comparative study was performed between I-shaped pillar design and conventional circle pillar design. 100% separation of bacteria was achieved for the I-shaped pillar array while separation was not observed for the circular pillar array. Moreover, separated bacteria were concentrated in a single stream (FIGS. 11c & 12a). This indicates that I-shaped pillar design can achieve efficient separation and concentration of non-spherical bacteria. Specifically, it can be seen that bacteria enter in the sample stream between channels 39-45 (FIG. 11a), deterministically are displaced towards channel-1 (FIG. 11b) and are concentrated in the channel-1 (FIG. 11c). FIG. 11b clearly shows the displacement path of bacteria through the I-shaped pillar array in a snap-shot while a similar snap-shot taken for the circle pillar array (control sample) did not show significant displacement of bacteria (FIG. 11d). For quantitative analysis, the percentage of bacteria passing through each input and output channels were calculated (FIG. 12). 100% of bacteria are deviated to the channel-1 for the I-shaped pillar array (FIG. 12a) while a wide distribution of bacterial output is observed for the circle pillar array which overlaps with the input channel streams. Since all parameters have been kept same for I-shaped and circle pillar array, except for the shape of pillars, it suggests that the shape of the pillar is responsible for the result. Moreover, it helps in concentration of bacteria as it can be located in a single stream (FIGS. 11c & 12a).

C. Separation of spherical bacteria: For studying the separation of spherical bacteria, S. epidermidis (Diameter=˜0.7 μm) was chosen. The array dimensions of the device used for this experiment were slightly different from the one used for separation of non-spherical bacteria (the gradient angle is 1.6° instead of 2.0°). This change was incorporated due to overall smaller size of spherical bacteria. Effective separation of spherical bacteria was also achieved by the I-shaped pillar design compared to the conventional design (FIG. 13).

D. Study of bacterial movement in I-shaped pillar array: To understand the bacterial separation in an I-shaped pillar array, bacterial movement was studied. It was interesting to note that bacteria move in see-saw motion through an I-shaped pillar array. Such movement allows taking shape into account and helps in the separation of non-spherical bacteria based on their shape (FIG. 14).

E. Separation of different types of bacteria in an I-shaped pillar array: The I-shaped pillar designed showed efficient separation of different types of bacteria including clinically relevant pathogenic species (FIG. 15).

F. Separation of bacteria from blood: in our study we have shown that bacteria can be separated from a pathologically relevant medium such as blood thus demonstrating that our technology can be developed into a highly commercially desirable product. Using an I-shaped pillar array design we have found that bacteria can be successfully removed from blood (FIG. 16).

### CONCLUSION

We have shown that a novel shaped pillar array is far more efficient in separating non-spherical entities, such as disc shape RBCs, from a fluid sample compared to conventional circle/cylindrical pillar arrays and square pillar arrays. The mechanism for the separation process is due to induced turning or rotations from undulating flow patterns caused by abutment surfaces and grooves on/in the pillars. The computational analysis and experimental results demonstrate that inducing turning or rotation of non-spherical particles increase their separation diameter. The invention has potential for the separation of bacteria and any other non-spherical particles in any fluid environment.

### REFERENCES

1. Pamme, N., Continuous flow separations in microfluidic devices. Lab Chip, 2007. 7(12): p. 1644-59.
2. Holm, S. H., et al., Separation of parasites from human blood using deterministic lateral displacement. Lab Chip, 2011. 11(7): p. 1326-32.
3. Huang, R., et al., A microfluidics approach for the isolation of nucleated red blood cells (NRBCs) from the peripheral blood of pregnant women. Prenat Diagn, 2008. 28(10): p. 892-9.
4. Loutherback, K., Puchalla, J., Austin, R. & Sturm, J. Deterministic microfluidic ratchet. Phys. Rev. Lett. 102, 045301 (2009).
5. Loutherback, K. et al. Improved performance of deterministic lateral displacement arrays with triangular posts. Microfluid Nanofluid 9, 1143-1149 (2010).
6. Sugaya, S., Yamada, M. & Seki, M. Observation of nonspherical particle behaviors for continuous shape-based separation using hydrodynamic filtration. Biomicrofluidics 5, 024103-024113 (2011).

TABLE 1
Flow and experiment parameters of the various pillar shapes
to be tested. The table shows pillar shapes with varying 3
parameters - protrusions, flow profile and orientation.

| | | PROTRU- | FLOW | ORIEN- |
|---|---|---|---|---|
| TYPE | PILLAR SHAPE | SIONS | PROFILE | TATION |
| (i) | [symbol] | 2 | Symmetrical | — |
| | I-shape | | | |
| (ii) | [symbol] | 2 | Symmetrical | Inverted |
| | Inverted Anvil Shape | | | |
| (iii) | [symbol] | 2 | Symmetrical | Upright |
| | Anvil Shape | | | |
| (iv) | [symbol] | 1 | Symmetrical | Inverted |
| | Inverted T-shape | | | |
| (v) | [symbol] | 1 | Symmetrical | Upright |
| | T-shape | | | |
| (vi) | [symbol] | 1 | Asymmetrical | Upright |
| | L-shape | | | |
| (vii) | [symbol] | 1 | Asymmetrical | Inverted |
| | L-shape Inverted | | | |

TABLE 2
Summary of data showing the converted separation index. An
index of more than 50 is highlighted in cyan. The index is based
on the mean separation of the particles within various devices.

| | | | | | RBC | RBC | |
|---|---|---|---|---|---|---|---|
| | | 2.5 um | 3.0 um | 3.5 um | SLOW | FAST | |
| PILLAR SHAPE | INPUT | SEPARATION INDEX | | | | | REMARKS |
| [symbol] | 1.1 | 5.7 | 91.7 | 94.8 | 95.4 | 61.5 | |
| I-shape | | | | | | | |
| [symbol] | 3.5 | 6.2 | 65.4 | 89.3 | 51.3 | 22.6 | |
| Inverted Anvil Shape | | | | | | | |
| [symbol] | 3.2 | 4.3 | 68.8 | 94.4 | 24.5 | 16.7 | |
| Anvil Shape | | | | | | | |
| [symbol] | 0.5 | 3.7 | 51.5 | 93.8 | 35.5 | 30.8 | |
| Inverted T-shape | | | | | | | |
| [symbol] | 7.6 | 7.8 | 42.0 | 89.1 | 45.2 | 24.0 | |
| T-shape | | | | | | | |
| [symbol] | 4.4 | 11.7 | 42.6 | 96.0 | 92.5 | 56.2 | |
| L-shape | | | | | | | |
| [symbol] | 2.5 | 3.3 | 47.7 | 88.6 | 20.9 | 3.6 | |
| L-shape Inverted | | | | | | | |

1. A microfluidic device for separation of particles in a fluid, the device including at least one pillar comprising, in cross-section, at least one particle abutment surface and an adjacent space that indents said pillar, or an adjacent groove that indents said pillar, to accommodate said particle.

2. The microfluidic device according to claim 1, including a pillar whose cross-section is selected from the group comprising: I-shaped, C-shaped, J-shaped, W-shaped, V-shaped, T-shaped, L-shaped, E-shaped and anvil-shaped.

3. The microfluidic device according to claim 1, including a pillar whose cross-section is I-shaped.

4. The microfluidic device according to claim 1, including a pillar whose cross-section is I-shaped and comprises a pair of oppositely positioned curvi-linear surfaces providing the central element of the I-shaped pillar and connecting with the two cross-membered ends of the I-shaped pillar.

5. The microfluidic device according to claim 1, including a pillar whose said abutment surface may be rounded or angular.

6. The microfluidic device according to claim 1, including a pillar wherein said space or groove is bounded by either a linear or a curvilinear surface.

7. The microfluidic device according to claim 1, including a plurality of pillars arranged in an array.

8. The microfluidic device according to claim 1, including a plurality of pillars arranged in an array wherein along at least one selected axis said pillars are aligned.

9. The microfluidic device according to claim 1, including a plurality of pillars arranged in an array wherein along at least one selected axis said pillars are staggered.

10. The microfluidic device according to claim 1, including a plurality of pillars arranged in an array wherein alternate rows of said pillars are inverted.

11. The microfluidic device according to claim 1, including a plurality of pillars wherein at least one of said pillars has a different cross-sectional shape with respect to said other or remaining pillars.

12-13. (canceled)

14. A method for separating particles in a fluid comprising:
a) providing in a microfluidic device a plurality of pillars comprising, in cross-section, at least one particle abutment surface and an adjacent space that indents said pillar, or an adjacent groove that indents said pillar, to accommodate said particle and further wherein said pillars are arranged in an array such that adjacent pillars define a space through which a fluid can flow;
b) causing a fluid to flow through said device;
c) making particles in said fluid rotate in at least one direction as they flow around said pillars;
d) collecting separated particles as they leave said array.

15. A method for separating particles in a fluid comprising:
a) providing in a microfluidic device a plurality of pillars comprising, in cross-section, at least one particle abutment surface and an adjacent space that indents said pillar, or an adjacent groove that indents said pillar, to accommodate said particle and further wherein said pillars are arranged in an array such that adjacent pillars define a space through which a fluid can flow and wherein pillars in either adjacent rows and/or columns are staggered so defining a space which requires lateral movement of particles flowing there through;
b) causing a fluid to flow through said device;
c) making particles in said fluid rotate in at least one direction as they flow around said pillars;
d) collecting separated particles as they leave said array.

16. The method according to claim 14 wherein said particles are non-spherical.

17. (canceled)

18. The method according to claim 14 wherein said particles are red blood cells.

19. (canceled)

20. The method according to claim 16, wherein the particles are selected from the group consisting of bioparticles, blood cells, bacteria, parasites, algae, and viruses.

21. The method according to claim 20, wherein the bacteria are selected from the group consisting of Escherichia, Staphylococcus, Klebsiella and Pseudomonas.

22. The method according to claim 15, wherein said particles are non-spherical.

23. The method according to claim 22, wherein the non-spherical particles are selected from the group consisting of bioparticles, blood cells, bacteria, parasites, algae, and viruses.

24. The method according to claim 23, wherein the bacteria are selected from the group consisting of Escherichia, Staphylococcus, Klebsiella and Pseudomonas.

25. The method according to claim 15, wherein the particles are red blood cells.
